(19) United States
(12) Patent Application Publication
(10) Pub. No.: US 2014/0267940 A1
(43) Pub. Date: Sep. 18, 2014

(54) LOW-POWER WEARABLE ELECTRONIC DISPLAY DEVICE

(71) Applicants: Nathan Ackerman, Seattle, WA (US); Daniel Wilson Bauman, Portland, OR (US)

(72) Inventors: Nathan Ackerman, Seattle, WA (US); Daniel Wilson Bauman, Portland, OR (US)

(21) Appl. No.: 14/213,929

(22) Filed: Mar. 14, 2014

Related U.S. Application Data
(60) Provisional application No. 61/790,523, filed on Mar. 15, 2013.

(51) Int. Cl. H04N 5/64

(52) U.S. Cl. CPC H04N 5/64
USPC 348/838

(57) ABSTRACT

The present disclosure is directed to a wearable, reprogrammable electronic display device that is configured to present user selected content with little to no power. The electronic display device may be programmed to display a specific image or string of text to be worn by the user. A personal computing device is configured to wirelessly or directly communicate with the electronic display device to program the content into the display device.

### CROSS-REFERENCE TO RELATED APPLICATIONS

This application claims benefit under 35 U.S.C. 119(e) to U.S. Provisional Patent Application No. 61/790,523, filed Mar. 15, 2013, which is incorporated by reference in its entirety.

### BACKGROUND

1. Technical Field

The present disclosure is directed to a low power wearable electronic display device.

2. Description of the Related Art

People frequently add broaches, pens, stickers, necklaces, jewelry and other accessories to their clothing and personal items. Often it is a way for them to express their own personality and individuality, and to make a personal statement that communicates their perspective on the world. For example, individuals that feel passionately about certain political ideas may express themselves through wearing a pin that has a phrase that conveys the party's ideals, or may have a symbol of the design or an animal that represents that party. Other individuals that feel passionately about a certain style or type of art may wear patches that show that type of art. Still others want to identify with people having common artistic or musical interests.

Sometimes these people will change the accessories they wear to match their current mood or feelings.

### BRIEF SUMMARY

The present disclosure is directed to provide a way for users to express themselves through a wearable, changeable electronic display device that can be worn on clothing or put on other personal articles like a handbag, scarf, hat, belt, backpack, or briefcase. The display device has a display screen that is able to display a single image, or display a sequence of moving images, such as a repeating pattern or a movie sequence. Letters and images can be displayed in either, black and white or color. Dimensions of a base of the device and a shape of the display are variable, i.e., it can be different shapes, for example a circle, a diamond, oval, or an irregular shape.

Users are able to choose content displayed on the display device, for example either by purchasing content from a content marketplace, or by using content that they already have stored on their local device, such as a personal computing device. Users are also able to create their own content, for example, by using graphics editing tools, or by taking pictures or movies and then editing them. This content would then be processed to make it displayable on the display device.

One or more embodiments include a wearable, changeable electronic display device, comprising a housing with a front panel and a back panel, the back panel having a fastening apparatus; a low-power display that requires minimal or no power to maintain its visual state; a connector for transferring data to and from the electronic display device; and a fastening apparatus for attaching the electronic display device either permanently or temporarily to an object. The display device may be used in all scenarios, including human or object identification, personal entertainment, or charity. The electronic display device may also include internal memory added for storing one or more pieces of audio or visual content. The electronic display device may also include a speaker for audio playback. The electronic display device may include a microphone for capturing audio. The electronic display device may include a touch input digitizer for capturing touch input on the surface of the device.

One or more embodiments may include a marketplace for content for the electronic display device, comprising the ability for users to create and upload content to the marketplace; the ability for content creators and owners to specify prices and terms for acquisition of their uploaded content; the ability for system users to browse, purchase, and acquire content from the marketplace and to transfer that content to their own display devices; enforcement of distribution rules between content owners and purchasers; and browsing all content, searching on key terms, or by viewing aggregates based on popularity, sales, or usage.

### BRIEF DESCRIPTION OF THE SEVERAL VIEWS OF THE DRAWINGS

For a better understanding of the present disclosure, preferred embodiments are now described, purely by way of non-limiting examples and with reference to the drawings. In the drawings, identical reference numbers identify similar elements or acts. The sizes and relative positions of elements in the drawings are not necessarily drawn to scale. For example, the shapes of various elements and angles are not drawn to scale, and some of these elements are enlarged and positioned to improve drawing legibility.

FIG. 1 is a schematic diagram of a networked environment associated with a user's wearable electronic display device, including various configured computing systems for creating, storing, browsing, searching, and transferring content to the electronic display device.

FIGS. 2A-2D are examples of an electronic display device attached to clothing and personal items.

FIG. 3A is one example of a front view of an electronic display device.

FIG. 3B is a side view of one example of a fastening apparatus and an electronic display device.

FIG. 4A is a front and back view of another embodiment of an electronic display device.

FIG. 4B is another embodiment of an electronic display device that is coupled to a computing device.

FIG. 5 is one way in which a user can change the content displayed on an electronic display device.

FIG. 6 is a system diagram showing one embodiment for implementing an electronic display device and electronic display device marketplace.

### DETAILED DESCRIPTION

FIG. 1 shows a schematic diagram of a networked environment for one embodiment associated with a wearable electronic display device 10 that may display a user selected image or video. The electronic display device 10 is configured to be worn by a user 12 on their clothing or placed in a location selected by the user, such as on a bag or other personal item. The electronic display device 10 may be a temporary accessory and, thus, can easily be removed and reattached at the user's discretion. The electronic display device 10 is programmable, such that the user 12 can display a selected image, phrase, or video. The display device is reprogrammable in that the user can select a different image or phrase or video at any time, as long as the user has access to the network or their personal computing device.

The electronic display device 10 receives content to display from any number of configured computing devices, such as the user's personal computing device 14. The personal computing device 14 may be a home computer or laptop, a cell phone, a smart phone, a tablet computer, or any other computing device sufficient to provide a signal to the electronic display device 10. The content may be pictures, video, sound, or other content, for presentation on the electronic display device 10. The content may be stored locally with the user 12, such as on a user's personal computing device 14 or the content may be stored in a remote storage device 16, like a cloud storage device. The storage device and the personal computing device are configured to communicate with the electronic display device 10, for example, with Bluetooth, near-field communications (NFC), such as using the “tap” feature, Wi-Fi, infrared, USB, ethernet, or any other form of electrical connection. Other storage devices may also include specialized computing or storage devices carried by the user that store content. In addition, other computing devices associated with a particular location, for example in a specific room or part of store, may be configured to communicate content directly to the electronic display device 10 through Wi-Fi. For example, a store could be offering an image or temporary use of their logo if a customer purchases something, such that upon purchase, the user's electronic display device 10 will receive the special image offered by the store through the wireless connection. The store may also send the user the content through their personal computing device to be stored in a content storage application 14a that runs on personal computing device 14.

As noted above, the content may also be stored remotely in the cloud or other remote storage 16, such as an Internet-based cloud. The content storage and distribution may also be facilitated by a cloud service 16a that runs in the cloud and is able to communicate directly with device 10 or to the personal computing device 14 by applications running on the personal computing device 14. Content may be located remotely in a physical content storage 18, which is accessible by cloud 16 or by cloud service 16a. Content may also be stored in content storage application 14a running on personal computing device 14.

The content may be provided directly by the content storage 14a or other storage that contains images, text, or other displayable information formatted appropriately for display on the electronic display device 10. The user may elect to convert an image they have taken or a phrase they have prepared into the format appropriate for display on the electronic display device 10. An optimization engine 22 is configured to receive an input from the user 12, such as an image 24 or a video 26 or some other convertible data that may be displayed on the display device 10. The optimization engine 22 converts the original format into a format displayable by the display device. For example, if the user selects a color image and the display device is a grayscale display, the optimization engine 22 converts the color image into a smaller, grayscale format.

One example will be described with respect to the content being an image 24. The image 24 may be a drawing created from scratch by using commercially available digital drawing tools. The image may also be a photograph taken by the user with a digital camera. The image could also be an image collected from a website, a piece of art, or other graphical representation of interest to the user. In these examples, the resulting images 24 go through an optimization process in the optimization engine 22 to convert the original format of the image to the format appropriate for the electronic display device 10. In one example, if the display device is a grayscale e-ink display, the format of the content will be a binary format, i.e., the information about the content will indicate whether each pixel or microcapsule is “on” or “off” (showing black or white). Other displays, such as a low power LCD screen may simply require a reduction in the number of pixels, such that the colors from the originally selected image may be represented on the LCD screen. The format change will be a reduction in the total number of pixels. In other color display examples, the range of colors available on the display may be less than the original image, so the original image is processed to generate a representative image for the display device.

The format of the content for display on the electronic display device 10 may be different depending upon the specific display for which the content is intended, or depending upon the format of the original content. The content is not limited to any single resolution, color, or representation—many sizes and representations can be saved to best suit the display on which it will appear. For example, image 24 may be a high-resolution photo with a pixel density that is far greater than a pixel density of the display device 10. In this case, the optimization engine 22 would lower the resolution of the image to match the display. In another example, the image 24 may be made of simple hand-drawn lines that are more easily convertible into the format of the display device. The optimization engine 22 may include a color filter application to make the image more appealing as displayed on the display device.

The content, once through the optimization engine 22, is not limited to any single resolution, color, or representation, i.e., many sizes and representations can be saved to best suit the display device 10 on which it will appear. For example, the display device may be any number of different sizes, shapes, and resolutions to provide the user with a variety of different options for presenting their selected information.

Although the optimization engine 22 is described in terms of graphics, other content can be similarly optimized. For example, videos 26 may be optimized by adjusting pixel density or frame rate. In addition, specific areas of a movie, such as the center of the screen, or the area around a main character's face, may be selected and the rest of the movie cropped out. For sound content, the optimization engine 22 may involve adjusting or eliminating certain sound frequencies to enable sound to be better heard through the electronic display device 10. The optimization engine 22 may also be performed as part of cloud service 16a, or may also be performed as an optimization application 14b running on personal computing device 14. Alternatively, the optimization engine 22 may be accessible from the user's personal computing device 14 through the cloud 16 for on-the-go optimization and display of the user's selected content.

The user 12 may also acquire content through buying and selling optimized content through a marketplace module 20. For example, the marketplace module 20 may offer the user 12 the opportunity to browse and acquire content to be loaded on electronic display device 10 through the cloud-based Internet service 16a. The content in the marketplace module 20 may already be optimized so that the user has access to a wide variety of content to display without having to select and process the images or videos or text through the optimization engine 22. The marketplace module 20 may provide the user 12 with access to select and acquire one of items 20a, 20b, 20c for a payment or for free. The cloud service 16a would track the relationship of user 12 and the acquired content as either a for-purchase or free distribution. An artist or provider may provide content of their own to others, by uploading the content into marketplace module 20. The artist or provider will have access to the optimization engine 22 to provide a way to convert their own artwork into a format receivable by the display device.

The artist or provider would then be able to control the distribution and price of the content to a variety of users. When a user 12 acquires content from the marketplace module 20, the content may be transferred via cloud 16 directly to the user's electronic display device 10, the personal computing device 14 within the content storage app 14a, or in another content storage area 18 for later transferring to electronic display device 10. The user may select where the selected content is stored. For example, the user may select that the content be transferred only to the display device 10. The cloud service 16a will track the user's purchases and uploads so that the user can re-access content previously selected and displayed. The previous purchases, downloads, and user-created content may be constantly accessible via the personal computing device 14 through the cloud 16.

Alternatively, the content may be temporarily displayed, such that the user 12 may select to display a selected image for a period of time. The user may also select to display a first image for a first period of time and then automatically display a second image for a second period of time. The electronic display device 10 may be programmed to have a timer and storage sufficient to save multiple images that the user elects to display in sequence.

The content stored into and retrieved from the marketplace module 20 would also include metadata that outlines rules for distribution of the content and includes, but is not limited to, price, resolution, allowed use, and other metadata. A user 12 who frequently uses and uploads content to the marketplace module 20 may be recognized publicly, such as through an award, token or publicity program, or the user may receive payment for items sold or acquired by other users. For example, if user 12 designs a specific image and uploads the image to marketplace module 20 with a cost of one dollar and after another user has purchased this piece of content, user 12 would receive $0.70 representing the sale of the uploaded content.

The marketplace module 20 may include one or more configured computing devices for providing a browsing function to look through existing content already formatted for presentation on the display device or through images, text, art, or other data that can be formatted for presentation on the electronic display device 10. The marketplace module 20 also includes a searching function that allows the user to search a database of previously formatted content by name of what the content represents, such as a representation of the Mona Lisa or a GO HAWKS! stylized phrase. The searching function may also allow the user to search their own subset of content previously purchased or created so that the user can easily access a specific image or video they want to display. The marketplace module 20 also provides an acquisition function that allows a user to purchase or otherwise select content available on the market place. For example, images created by one artist may be purchased by a user for display on the display device. The marketplace module 20 may be configured to track the number and length of time that a user displays the acquired content to provide the artist with a way to track potential royalty payments for continued or repeated use of their artwork. The artist may opt to display their artwork for free in the marketplace module 20, while opting to track and share the number of pieces and number of times the pieces have been displayed as content on a user's display device.

The content can be found by browsing all content, searching on key terms, or by viewing aggregates based on popularity, sales, or usage. The marketplace module 20 is configured to track this information and maintain an easily manipulable and searchable database of the content available. The marketplace module 20 may allow for filtering based on a size and shape of the display device. For example, if the display device is a starburst shape, certain images would not present well on each of the radiating arms of the star. Accordingly, the marketplace module 20 may provide the user with content options that are successfully displayable on the display device. In addition, different devices may have different resolutions based on the type of display. For example, an e-ink grayscale display will create a different impression than a color LCD screen. The marketplace module 20 will allow for filtering based on the type of display.

Artists and other providers can create artwork and upload the artwork to marketplace module 20. The artwork may be formatted or otherwise optimized prior to uploading to marketplace module 20 or after upload to marketplace module 20. For example, in some embodiments, user 12 may format the selected content on their personal computing device in the optimization application 14b. This may be beneficial if the user has several shapes and sizes of display devices. In addition, it allows the user to modify their display device on the go. For example, if the user had GO HAWKS! on their display device as they were watching the Super Bowl, user could reprogram the display device after the Seahawks won to present SUPER BOWL 48 CHAMPS.

The marketplace module 20 is configurable to allow the artists and other providers to specify prices and terms for the acquisition of their content. The marketplace module 20 is configured to enforce distribution rules between content owners and purchasers. Once purchased or otherwise acquired, the user 12 receives the content from the marketplace module 20 and either immediately displays the content on the electronic display device 10 or stores the content for future presentation.

FIGS. 2A-2D are various representations of a round electronic display device 26 according to an embodiment of the present disclosure. In FIG. 2A, the round electronic display device 26 is attached to a wearable piece of clothing, such as a t-shirt 24. The round electronic display device 26 may be temporarily attached, and can be easily removed and re-attached to the t-shirt 24.

In one embodiment, the round electronic display device 26 is an e-ink display that requires little power and can hold an image for a long period of time. E-ink is a type of electronic paper that can be in color or in grayscale. E-ink technology is different from conventional backlit panel displays that emit light in that, E-ink technology reflects light similar to standard print on paper. These displays only require power to create the image or text. No or very little power is utilized to maintain the image. This round electronic display device 26 may include e-ink technology that can hold the content static indefinitely without using any power.

There are various types of e-ink technology, such as electrophoretic display, which includes tiny microcapsules filled with electrically-charged white particles suspended in a colored oil. The microcapsules are positioned between two arrays of electrodes, which may be transparent. The white particles may be slightly charged so that when a charge is applied to the arrays of electrodes, the microcapsules rotate and either show the white particles or the color oil. The two arrays of electrodes may be arranged to be divided into pixels, where each pixel corresponds to a pair of electrodes separated by a group of microcapsules. The arrays of electrodes are connected to display circuitry, which controls whether the ink is “on” or “off.”

The round electronic display device 26 may be any one of a variety of display devices; however, utilizing e-ink technology allows for the display device to have a small power source, both in size and power provided. A smaller power source allows the round electronic display device 26 to be thin or even flexible. In some embodiments, the round electronic display device 26 will not have a power source and instead will receive power from the personal computing device 14 providing the optimized content. In particular, the round electronic display device 26 may be charged and receive the content from the personal computing device 14. In addition, any type of low power display device may be utilized as the round electronic display device 26.

In another embodiment, the round electronic display device 26 may be a low power liquid crystal display screen that includes a small battery on board with the device. Alternatively, a low power LED screen may also be used.

The round electronic display device 26 includes a border 25, visible from a front view, and a display panel 27. The border 25 may be programmable to illuminate with a different color or complement the image on the display panel 27. As mentioned above, the display panel 27 may be an e-ink display or some other programmable digital display. Preferably, the display panel 27 utilizes little to no power to maintain the image and thus, can be programmed and worn or carried for a long period of time.

FIG. 2B is a hoodie or sweat shirt 28 that includes two of the round electronic display devices 30, 32 attached to cuffs of the sleeves. In one embodiment, round electronic display devices 30 32 may replace pre-existing functional accessories such as cufflinks, buttons, clasps, broaches, and the like that provide functional support to clothing or other objects. As noted above, the round electronic display devices 30, 32 may be other shapes, such as square, elongated rectangles, or an irregular pattern. For this arrangement, user 12 may select elongated rectangular display devices that can wrap around the user's wrists to form a user-selected, electronic bracelet. The user may create a bracelet from their own favorite pattern and color scheme. Alternatively, the user may display their gamer tag on their display device if they are heading to a gaming event. The user can select a color, text, and image combination to achieve any personalized representation. Once programmed the display device can be worn for hours and days without additional power or programming.

In order to provide a comfortable fit for the user, the display device may be formed from flexible, bendable, soft material. Alternatively, such as if the display device is utilized as a cuff link, the display device may be rigid. As noted with respect to FIG. 2B, the border 25 may be rigid and support the display panel 27. In some embodiments, the display panel may be removable, such that the display panel 27 may be removed from the rigid border 25 and attached to a different border. For example, a border that is star-shaped or some other shape.

The display devices may be configured to communicate with adjacent display devices. For example, the two display devices attached to the cuffs of the hoodie 28 may be able to share content with each other. This can allow a friend to share content with another display device. In one embodiment, the display devices are configured to utilize near field communications to transfer information about content and parameters of the display.

FIG. 2C is another display arrangement of an electronic display device 36 that is attached to a non-clothing object 34, such as a backpack. The electronic display device 36 may be attached to a car, a wall, a desk, a chair, or any other object the user selects. The electronic display device 36 may or may not be physically wearable by a human being.

FIG. 2D is another display arrangement of an electronic display device 40 physically integrated into other articles of clothing, such as a belt. The electronic display device 40 could be integrated with the belt to act as a belt buckle. Instead of a more traditional fastening device, like a pin, the fastening device may be a loop and a hook to secure a belt around a user. Other examples of physical integration into articles of clothing include pants and hats. The electronic display device 40 may or may not play a functional role with respect to clothing item 38.

This electronic display device 40 may be formed to have a rigid border 41 onto which a display panel 43 is attached. The rigid border 41 may provide a location to attach a housing that includes the display circuit, a power source, and an attachment component. Alternatively, the rigid border 41 may be a housing that incorporates or houses the other components to be discussed in more detail below. Because this electronic display device 40 is worn on an area of the body that can bump into firm surfaces, the display panel 43 may be formed from a more rigid and resilient material than the embodiment that can be worn as a bracelet.

FIG. 3A is a front view of an electronic display device 42 having an accompanying display panel 44 that comes in a selected shape and size. The electronic display device 42 may include a support 70. The support 70 may be bigger or wider than the electronic display panel 44, such that the support 70 forms a border. The support 70 may be the same size as the electronic display panel 44. The support 70 may also be configured to display content such that the electronic display panel 44 and the support 70 can present complementary images or the support 70 can be a panel of LEDs that cause the border to glow a different color.

In this case, the electronic display panel 44 is a starburst shape and the support 70 is a larger but similarly shaped starburst. However, the shape can be selected by the user and is not limited to any regular geometric shape and is not limited to two dimensions. For example, the electronic display panel 44 may be curved inwardly or outwardly. In addition, the electronic display panel 44 may be flexible so that the panel can move with the movement of the user.

FIG. 3B is a side view of an electronic display device 51 having a display panel 52 that is attached to an object 50. The display device 51 includes an electronic display device housing 46 that couples to a fastening apparatus 48 to couple the housing 46 to the display panel 52. The fastening apparatus 48 may be a magnet that attaches the display panel 52 to the object 50 through magnetism. In other embodiments, the display device 51 is attached completely from one side of the object. Other examples of fastening apparatus 48 include a pin or adhesive. The display panel 52 may include an additional magnet to attach the panel to an object. Attachment of electronic display device housing 46 may or may not be temporary with respect to object 50.

FIG. 4A shows another embodiment of a wearable, adjustable, low-power, electronic display device 55. The electronic display device 55 has a front surface 54 onto which a display panel 58 is attached. The electronic display device 55 includes a back housing 56. The front surface 54 may be a front side of the back housing 56 or the front surface may be a separate piece of material. The display panel 58 can display any number of images, monochrome as well as color, videos, QR codes, text, barcodes, or any other visual content. The display panel 58 may present a static image, play video, or display other visual content or cycle through a set of defined content. The display panel 58 may or may not require power to constantly maintain the desired visual state. Examples of display panel 58 include e-ink, e-paper, and liquid crystal displays. The back housing 56 of the electronic display device 55 contains a connector 60 for transferring data to and from the electronic display device. The connector 60 may transfer data, for example via Bluetooth, Wi-Fi, or via wired technologies such as USB. The back housing 56 includes additional components 62. The additional components 62 may be a power supply, such as a watch battery that is coupled to the display panel and to display circuitry. The additional components 62 may also be a microphone for recording audio or a speaker for playing audio.

FIG. 4B shows another embodiment where a connection mechanism 74 is established between the electronic display device 70 and a personal computing device 78. The connection mechanism 74 may be either physical such as a USB cable or wireless connection, for example, Bluetooth or Wi-Fi. The connection mechanism 74 may be facilitated by connectors 72 and 76. For example, a physical USB connection mechanism 74 would connect USB terminals 72 and 76. Examples of the personal computing device 78 include, but are not limited to, a server connected to the Internet, a personal computer desktop, a laptop, a tablet, a mobile phone, another electronic display device or any other personal computing device.

FIG. 5 is an example of one method of changing the content displayed on an electronic display device 68. This display device 68 does not include a border and instead includes a housing (not shown) onto which a display panel is attached. The display panel includes a display technology, such as e-ink, and touch screen or proximity detection technology. In particular, a user's hand 64 or other physical body part, through physical contact or a proximity gesture 66, can control the content presented on the electronic display device 68. For example, if the display device has memory that has stored a first image and a second image, the user may select which image to display by interacting with the display device. The user may tap the front surface of the display panel to cause the image to change. Alternatively, the user may swipe from one side of the panel to another to change the image. The user may select a direction of swiping that is sufficient to change the image so that the image does not change if unwanted movement is detected.

In one embodiment, the display panel includes capacitively coupled electrodes that are configured to detect a physical touch by a user on the front surface of the display panel. The capacitively coupled electrodes may be integrated with the array of electrodes used to control the e-ink capsules.

In another embodiment, the housing or back panel may include a physical button that can be pressed when the user wants to cycle through the content stored in the memory of the display device. Alternatively, if there is a border, the border may include the physical touch or proximity detection to detect when a user opts to change the content.

The gesture 66 can be a relative command to advance the content displayed on the electronic display device 68 or can be an absolute command to display a specific piece of content. As an example, a user may gesture 66 using touch on the front of the electronic display device to have it change to the next piece of content on the device. Another example includes touching in a specific pattern or gesture 66 on the surface of the electronic display device 68 to have the electronic display device display a specific piece of content. In addition to changing visual content, initiation of gestures 66 can cause audio playback from the speaker, or start recording from the microphone of device 68.

As noted above, each display device is adaptable in that the display device may be coupled to an object or to the use's clothing or the display device may be held on a chain or necklace. In other embodiments, the display device is attached to a wall or a desk. The device is versatile is where and how it can be attached. In addition, it could be permanently fixed or temporarily attached to the object. The fastening apparatus described above may include a magnet, pin, or adhesive.

FIG. 6 is a system diagram of a computing system for implementing embodiments of a changeable wearable electronic display device. FIG. 6 includes a computing system 600 that may be utilized to implement a programmable electronic display device system (“PEDD” system 604) as described above. One or more general purpose or special purpose computing systems may be used to implement the PEDD system 604. More specifically, the computing system 600 may comprise one or more distinct computing systems present at distributed locations, such as a user's personal computing device and a marketplace providers server center. In addition, each block shown may represent one or more such blocks as appropriate to a specific embodiment or may be combined with other blocks. Moreover, the various blocks of the PEDD system 604 may physically reside on one or more machines, which may use standard inter-process communication mechanisms (e.g., TCP/IP) to communicate with each other. Further, the PEDD system 604 may be implemented in software, hardware, firmware, or in some combination to achieve the capabilities described herein.

In the embodiment shown, computing system 600 comprises a computer memory 602, a display 608, one or more Central Processing Units (“CPU”) 610, Input/Output devices 612 (e.g., keyboard, mouse, joystick, track pad, CRT or LCD display, and the like), other computer-readable media 614, and network connections 616. The PEDD system 604 is shown residing in memory 602. In other embodiments, some portion of the contents, some of, or all of the components of the PEDD system 604 may be stored on and/or transmitted over the other computer-readable media 614 or over network connections 616. The components of the PEDD system 604 preferably execute on one or more CPUs 610 and generate content from images and other information input into the system by users or administrators, as described herein. Other code or programs 620 (e.g., a Web server, a database management system, and the like) and potentially other data repositories, such as data repository 624, also reside in the memory 602, and preferably execute on one or more CPUs 610. Not all of the components in FIG. 6 are required for each implementation. For example, some embodiments embedded in other software do not provide means for user input, for display, for a customer computing system, or other components. For example, the changeable wearable electronic display device itself.

In a typical embodiment, the PEDD system 604 includes a content acquisition engine 606, an optimization engine 624, a content storage manager 626, an interface engine 628, and a content repository 630. Other and/or different modules may be implemented. In addition, the PEDD system 604 interacts via a network 632 with changeable wearable electronic display devices 634, a marketplace management system 636, and/or a local device (e.g. smart phone) 638.

The content acquisition engine 606 performs at least some of the functions of acquiring content described with reference to FIG. 1. In particular, the image acquisition engine 606 interacts with the user and other systems to obtain content and in one embodiment stores that content in the content repository 630 for processing by other components of the PEDD system 604. In some embodiments, the content acquisition engine 606 may act as a content cache manager, such that it preferentially provides content to other components such as the changeable wearable electronic display device 634 or local device (e.g. smart phone) 638. In other embodiments, images may be first processed by the optimization engine 624 and then sent out to other modules, without intervening storage in the content repository 630.

The optimization engine 624 performs at least some of the functions of the optimization engine described with reference to FIG. 1. In particular, the optimization engine 624 generates content optimized for display on a wearable display device that is obtained from the content repository 630, from other computer readable media 614, or from the marketplace management system 636. In addition, at least some aspects of optimization 624 may be performed automatically, based on image processing and/or image understanding techniques. After the content is optimized, the content store manager 626 stores the optimized content in the content repository 630 and is ready for display. In some embodiments, the content store manager 626 will store the optimized content into the data repository 622, marketplace management system 636, local device 638, or directly to the changeable wearable electronic display device 634.

In some embodiments, the interface engine 628 provides programmatic access to one or more functions of the PEDD system 604. For example, the interface engine 628 provides a programmatic interface (e.g., as a Web service, static or dynamic library, etc.) to one or more content formatting functions of the PEDD system 604 that may be invoked by one of the other programs 620 or some other module. In this manner, the interface engine 628 facilitates the development of third-party software, such as user interfaces, plug-ins, adapters (e.g., for integrating functions of the PEDD system 604 into desktop applications, Web-based applications, embedded applications, etc.), and the like. In addition, the interface engine 628 may be in at least some embodiments invoked or otherwise accessed via remote entities, such as the marketplace management system 636, the local device (smart phone) 638, or the changeable wearable electronic display device 634.

The content repository 630 stores optimized content and associated metadata, including data described in FIG. 1. In addition, the content repository 630 may include information about customers, operators, or other individuals or entities associated with the PEDD system 604.

In an example embodiment, components/modules of the PEDD system 604 are implemented using standard programming techniques. For example, the PEDD system 604 may be implemented as a “native” executable running on the CPU 610, along with one or more static or dynamic libraries. In other embodiments, the PEDD system 604 is implemented as instructions processed by virtual machine that executes as one of the other programs. In general, a range of programming languages known in the art may be employed for implementing such example embodiments, including representative implementations of various programming language paradigms, including but not limited to, object-oriented (e.g., Java, C++, C#, Matlab, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), declarative (e.g., SQL, Prolog, and the like).

The embodiments described above may also use well-known synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs, or in a cloud-based environment. Some embodiments execute concurrently and asynchronously, and communicate using message passing techniques. Equivalent synchronous embodiments are also supported by a PEDD system implementation. Also, other functions could be implemented and/or performed by each component/module, and in different orders, and by different components/modules, yet still achieve the functions of the PEDD system 604.

In addition, programming interfaces to the data stored as part of the PEDD system 604, such as in the content repository 630, can be available by standard mechanisms such as through C, C++, C#, and Java APIs; libraries for accessing files, databases, or other data repositories; through scripting languages such as XML; or through Web servers, FTP servers, or other types of servers providing access to stored data. For example, the content repository 630 may be implemented as one or more database systems, file systems, memory buffers, or any other technique for storing such information, or any combination of the above, including implementations using distributed computing techniques. The content repository 630 may also be implemented using third-party products for data replication, such as Evernote™ or Dropbox™.

Also, the example content repository 630 can be implemented in a distributed environment comprising multiple, even heterogeneous, computer systems and networks. For example, in one embodiment, the content acquisition engine 606, optimization engine 624, content storage manager 626, the interface engine 628, and the content repository 630 are all located in physically different computer systems. In another embodiment, various modules of the content repository 630 are hosted each on a separate server machine and are remotely located from the tables which are stored in the data repository 622. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like).

Furthermore, in some embodiments, some or all of the components of the PEDD system 604 are implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), and the like Some or all of the system components and/or data structures may also be stored (e.g., as software instructions or structured data) on a computer-readable medium, such as a hard disk, a memory, a network, or a portable media article to be read by an appropriate drive or via an appropriate connection. The system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

The wearable electronic display device 634 is configured to receive updates to firmware through the same mechanisms that it receives content and in some cases, powers from the personal computing device. The display device may automatically start charting or updating its firmware when in close proximity to a designated base or support. Alternatively, the display device may have to be physically coupled to the personal computing device to begin the transfer.

The marketplace provides the user with a browsing and searching experience to select content for their device. The user can select an item or image to acquire either for money or for free by means of interacting with the cloud-based Internet service marketplace. The cloud-based Internet service marketplace logically stores the relationship of the user and the acquired content as either purchase or free distribution. The owning user who uploaded the content into the system controls distribution and price of content. The owning user may set parameters through which they control the distribution of their content, such as monitoring whether the user has been granted free access to the content or has proven sufficient payment for the content. If the conditions are met, the content is logically transferred either directly to the display device or transferred indirectly to storage or the personal computing device for eventual transfer to the display device. Ultimately, the desired or purchased content will be transferred to the display device.

Content creators and/or content owners have the ability to specify metadata and transfer content to a cloud-based Internet service. Metadata can outline rules for distribution of the content and includes, but is not limited to, price, resolution, usage, and other metadata. At a later time, a user will be recognized publicity or paid with currency for items that were sold or acquired by other users in the system.

The present disclosure also includes a computer-implemented method for displaying content on a wearable electronic display device, the method comprising: acquiring content to be displayed on the wearable electronic display device; optimizing the acquired content for display on the wearable electronic display device; transmitting the optimized content to the wearable electronic display device for display; and displaying the optimized content on the wearable electronic display device. The computer-implemented method for displaying content on the wearable electronic display device includes displaying the content on the wearable electronic display device and storing the optimized content in a content repository. The acquired content is a sequence of one or more digital images; and wherein optimizing the acquired content further comprises: adjusting the pixel density of the one or more digital images to match the pixel density of the wearable electronic display device.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a housing with a front panel and a back panel;
a display connected to the front panel, the display being configured to present an image and maintain the image in a static state without continuous application of power;
a connector coupled to the display, the connector configured to transfer data to the display about the image; and
a fastening apparatus connected to the back panel, the fastening apparatus configured to attach the back panel to an object.

2. The device of claim 1 wherein the display is an e-ink display.

3. The device of claim 1, further comprising:
a display circuit coupled to the connector and positioned on the back panel, the display circuit configured to receive information about the image and present the image on the display; and
a microphone and speaker to the display circuit, the display circuit configured to control the microphone and speaker.

4. The device of claim 3, further comprising:
memory coupled to the connector and the display circuit, the memory configured to receive and store the information about the image.

5. The device of claim 1 wherein the display includes a touch-sensitive component.

6. The device of claim 5 wherein the touch-sensitive component is configured to receive inputs to adjust the image presented by the display.

7. The device of claim 1 further comprising memory coupled to the display and the connector, the memory being configured to store information about the image.

8. The device of claim 7 wherein the image includes text.

9. The device of claim 7, further comprising a speaker coupled to the memory, wherein the image includes audio and visual content.

10. The device of claim 9 wherein the memory stores the audio and visual content.

11. The device of claim 10 wherein the display is configured to display a first portion of the image for a first period of time and to change the display to a second portion of the image for a second period of time.

12. The device of claim 1, further comprising a microphone and a storage device, the storage device being coupled to the display, the microphone, and the connector, the storage device being configured to store audio captured by the microphone.
